(19) United States
(12) Patent Application Publication
(10) Pub. No.: US 2009/0045654 A1
(43) Pub. Date: Feb. 19, 2009

(54) DOOR CLOSURE PREVENTION TOOL AND VEHICLE BODY COATING METHOD USING THE TOOL

(75) Inventor: Eiichi Yoshida, Tokyo (JP)

Correspondence Address: STANDLEY LAW GROUP LLP, 6300 Riverside Drive, Dublin, OH, 43017, US

(73) Assignee: HONDA MOTOR CO., LTD., Tokyo (JP)

(21) Appl. No.: 12/091,759

(22) PCT Filed: Oct. 26, 2006
(86) PCT No.: PCT/JP2006/321926

§ 371 Date: May 12, 2008

(30) Foreign Application Priority Data
Oct. 28, 2005 (JP) 2005-315307

(51) Int. Cl. B60N 3/00; B01D 57/02

(52) U.S. Cl. 296/207; 204/472

(57) ABSTRACT

A door closure prevention tool (20) interposed between a vehicle body (10) and a door (11) when the door must be brought to a slightly open position, wherein the door closure prevention tool (20) allows locking to be released by a robot arm (75), and movement from a slightly open position to a completely open position to be performed by the robot arm. A vehicle body coating method using the tool is also disclosed.

### TECHNICAL FIELD

The present invention relates to an improvement in a tool that restrains a door such that the door does not close.

### BACKGROUND ART

A vehicle body is often coated on the inside and outside by filling a paint tank with paint and immersing the vehicle body in the paint tank. If the vehicle body is coated while a door attached to the body is closed, part of the paint remains inside the vehicle after the vehicle body is hoisted out of the paint tank. If the door is left slightly open, then there is no concern over paint remaining inside the vehicle, because the paint spills out through the gap in the door. When the door is to be left slightly open, a door closure prevention tool is needed. Such a door closure prevention tool is disclosed in Japanese Utility Model Post-Exam Publication No. 4-22678. The structure of this door closure prevention tool is described hereinbelow with reference to FIG. 13 hereof.

An open door holding tool 100 is composed of a base plate 103 fixed to a vehicle body 101 by a bolt 102, an operating bar 105 rotatably attached to the distal end of the base plate 103, and engaging pieces 106, 107 provided in bifurcated fashion at the distal end of the operating bar 105, as shown in FIG. 13.

The operating bar 105 is first turned so that the engaging pieces 106, 107 reach the positions of the imaginary lines. A door 104 moves from the top of the diagram to the bottom. The door 104 can be moved without interference at this time, because a hole 109 formed in an inner panel 108 does not extend to the engaging pieces 106, 107. When the inner panel 108 reaches a position in the middle between the engaging piece 106 and the engaging piece 107, the door 104 stops moving, and the operating bar 105 is turned to the position of the solid lines. There is no need for concern over the door 104 closing, because the inner panel 108 is restrained from moving by the engaging pieces 106, 107.

In cases in which the open door holding tool 100 is used in a vehicle body coating line, an operator rotates the operating bar 105. Coating by using a coating gun is predominately performed automatically by coating robots. Since the operating bar 105 is operated manually, it has heretofore been difficult to completely automate the coating line.

Due to the demand for improved productivity and automation, a need exists for a door closure prevention tool wherein the operating bar 105 can be operated by a robot.

### DISCLOSURE OF THE INVENTION

According to a first aspect of the present invention, there is provided a door closure prevention tool interposed between a body and a door of a vehicle when the door, which is secured on a right or left side thereof to the vehicle body by hinges, is required to be brought to a slightly open position, the door closure prevention tool comprising: a tool base fixed to the vehicle body by a screw; a closure restraining member extending from the tool base towards the door for preventing the door from closing from the slightly open position; an opening restraining member extending from the tool base to a position of engaging the door for preventing the door from opening farther than the slightly open position; an elastic member for enabling the opening restraining member to be moved from a position of not engaging the door to the position of engaging the door and to elastically push the opening restraining member to the position of engaging the door; a first annular member protruding horizontally from the opening restraining member and being operable by a vertical rod provided to a robot arm such that the opening restraining member is moved to a position that does not interfere with the door; and a second annular member, having a diameter larger than a diameter of the first annular member and protruding horizontally from the door at a position above the first annular member, for opening the door by being operated by the vertical rod which moves the opening restraining member to the position that does not interfere with the door.

When one operation is completed and the door is to be opened completely, the vertical rod provided to the robot arm is inserted into the second annular member and the first annular member, and the lower first annular member is moved, releasing the restraining action of the closure restraining member. This release is then maintained while the second annular member is moved by the vertical rod to open the door. Specifically, the coating line can be completely automated because the door can be opened by a robot.

According to another aspect of the present invention, there is provided a vehicle body coating method comprising the steps of: attaching a door closure prevention tool, according to claim 1, to a predetermined position of a vehicle body having a door; performing electrodeposition coating on the vehicle body by immersing the vehicle body in an electrodeposition tank with the door kept slightly open via the door closure prevention tool; coating, by using a coating robot, an outer surface of the vehicle body pulled out of the electrodeposition tank; causing a vertical rod of a robot arm to act on the door closure prevention tool to completely open the door; and coating an inner surface, including that of the door, of the vehicle body.

### BRIEF DESCRIPTION OF DRAWINGS

Certain preferred embodiments of the present invention will be described in detail below, by way of example only, with reference to the accompanying drawings, in which:

FIG. 1 is a perspective view illustrating a mode of mounting the door closure prevention tool according to the present invention;

FIG. 2 is a perspective view showing a tailgate kept in a slightly open position by the door closure prevention tool according to the present invention;

FIG. 3 is an enlarged perspective view showing the details of the door closure prevention tool according to the present invention;

FIG. 4 is a cross-sectional view taken along line 4-4 of FIG. 3;

FIG. 5 is a cross-sectional view taken along line 5-5 of FIG. 3;

FIG. 6 is a flowchart describing the method of coating the vehicle body;

FIG. 7A is a schematic view of the tailgate in a slightly opened position, with a robot facing the tailgate to open the tailgate wider;

FIG. 7B is a partial enlarged view of FIG. 7A;

FIG. 8A is a view of a vertical rod being inserted through first and second annular members from above;

FIG. 8B is a partial plan view of FIG. 8A;

FIG. 9A is a view illustrating an operation of the vertical rod;

FIG. 9B is a partial plan view of FIG. 9A;

FIGS. 10A and 10B are schematic views illustrating the tailgate being opened wide;

FIG. 11A is a schematic view illustrating the wide-open tailgate being closed by the robot;

FIG. 11B is a partial enlarged view illustrating an operation of the vertical rod shown in FIG. 11A;

FIGS. 12A through 12C are schematic views illustrating an operation of the vertical rod, continuing from the operation shown in FIG. 11B; and

FIG. 13 is a schematic view illustrating the basic construction of a conventional door closure prevention tool.

### BEST MODE FOR CARRYING OUT THE INVENTION

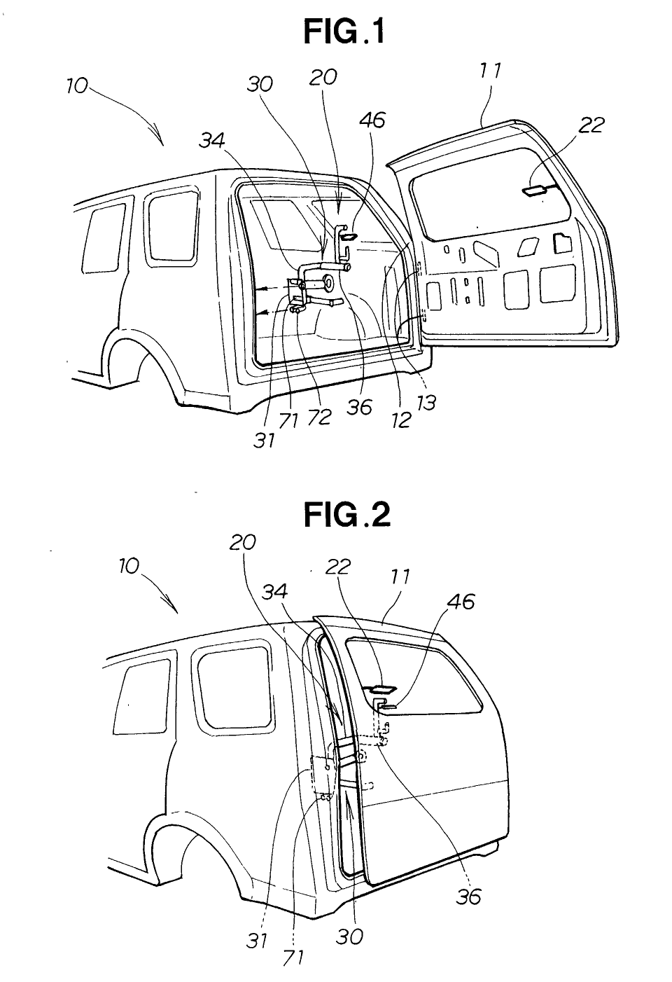

A door 11, referred to as a tailgate, is provided at the rear side of a vehicle body 10, as shown in FIG. 1. This door 11 is a so-called side-opening door, attached by hinges 13, 13 to the longitudinal edge 12 at the rear of the vehicle body 10.

A door closure prevention tool 20 is composed of a door closure prevention tool unit 30 attached to the vehicle body 10, and a second annular member 22 attached to the door 11.

The door 11 is kept slightly open by the door closure prevention tool unit 30 attached to the vehicle body 10, as shown in FIGS. 2 and 5. If the door is kept slightly open, then paint inside the vehicle can quickly spill out.

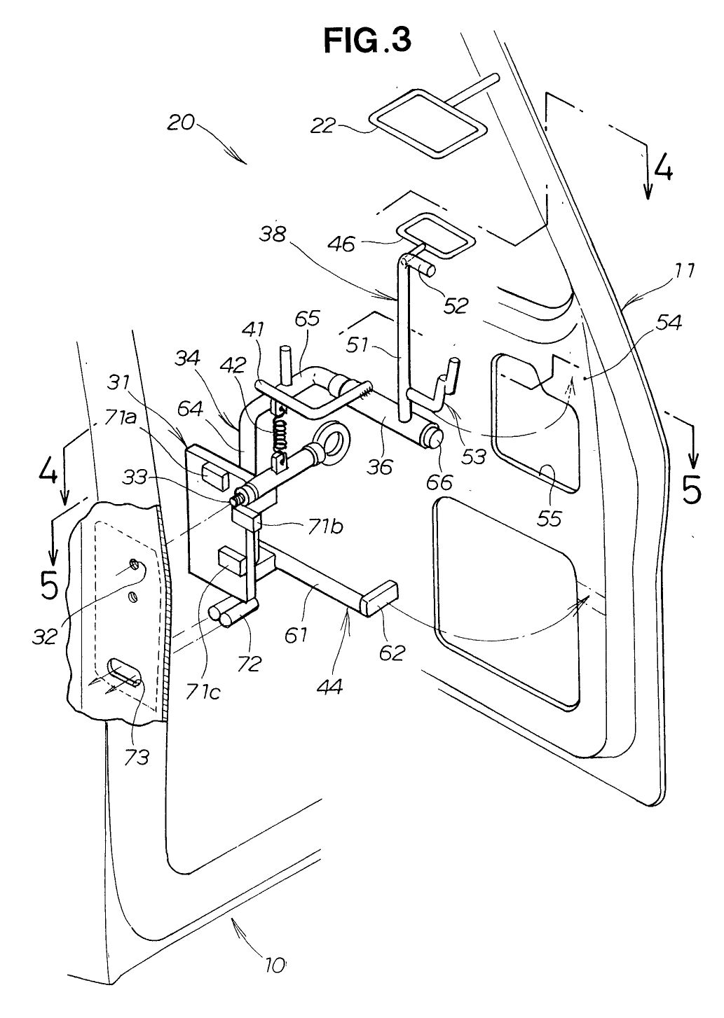

As shown in FIG. 3, the door closure prevention tool 20 has a tool base 31, a screw 33 for fixing the tool base 31 in place by being threaded into an internal thread 32 formed in the vehicle body 10, an arm member 34 extending from the tool base 31 towards the door 11, a rotating tube 36 attached to the arm member 34 to be capable of rotating around a longitudinal axis of the vehicle body, an opening restraining member 38 that extends from the rotating tube 36 and restricts the opened position of the door 11, a stopper member 41 that extends from the rotating tube 36 and restricts the rotation of the rotating tube 36 by coming in contact with the arm member 34, an elastic member 42 that spans the distance between the stopper member 41 and the tool base 31 and pulls the stopper member 41 toward the arm member 34, a closure restraining member 44 that extends from the tool base 31 and restricts the closed position of the door 11, a first annular member 46 that is shaped as a rectangular annulus and that extends horizontally from the top of the opening restraining member 38, and a second annular member 22 that is larger in diameter than the first annular member 46 and that is attached to the door 11 at a position above the first annular member 46.

The opening restraining member 38 is composed of a vertical rod 51 extending upward from the rotating tube 36, a horizontal part 52 extending horizontally from the top end of the vertical rod 51, and a bottom catch 53 that extends horizontally from the bottom of the vertical rod 51 and then extends upward.

The bottom catch 53 can be diverted to the reverse side of a door inner member 54 by passing through a hole 55 formed in the door inner member 54, as shown by the transparent line. The opened position of the door 11 can then be restrained.

The closure restraining member 44, is composed of a lower arm 61 extending from the tool base 31, and a receiving part 62 attached to the distal end of the lower arm 61. This receiving part 62 is brought into contact with the surface of the door inner member 54, whereby the closed position of the door 11 can be restrained.

The door 11 can thus be kept slightly open relative to the vehicle body by the opening restraining member 38 and the closure restraining member 44.

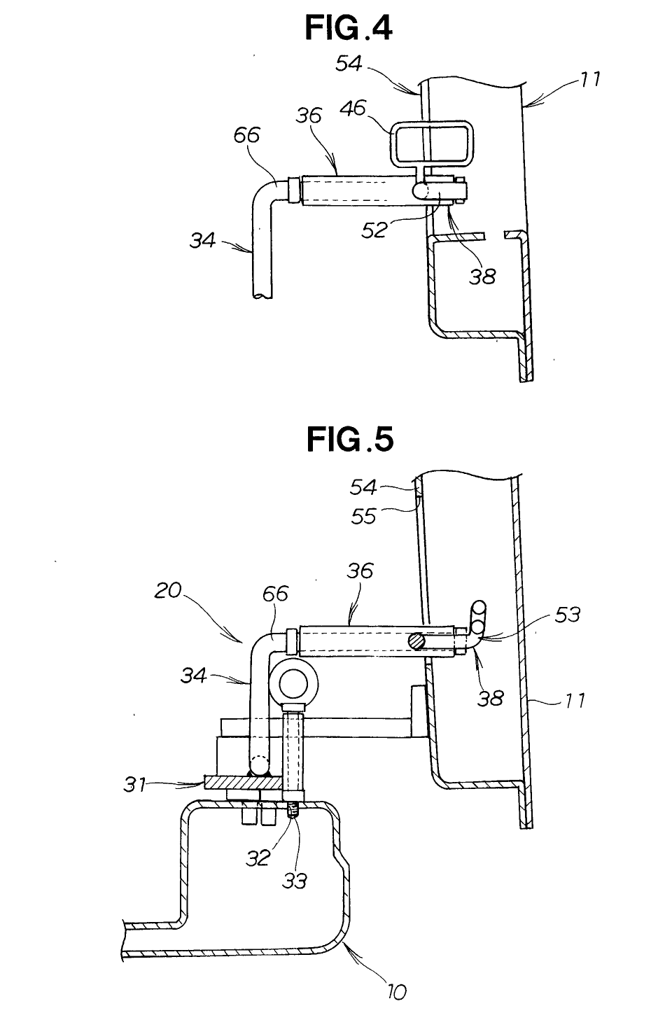

The arm member 34 is composed of a vertical part 64 extending upward, a horizontal part 65 extending from the vertical part 64 in the width direction of the vehicle body, and an end part 66 extending from the horizontal part 65 towards the door 11. The rotating tube 36 is rotatably provided at the end part 66 as shown in FIG. 4.

The numerical symbols 71a through 71c indicate pads that are attached to the tool base 31 and that are located between the tool base 31 and the vehicle body 10, and the numerical symbol 72 indicates a positioning pin that fits into a long hole 73 formed in the vehicle body 10 and that positions the door closure prevention tool 20 on the vehicle body 10.

The following is a description of the coating process performed using the door closure prevention tool described above.

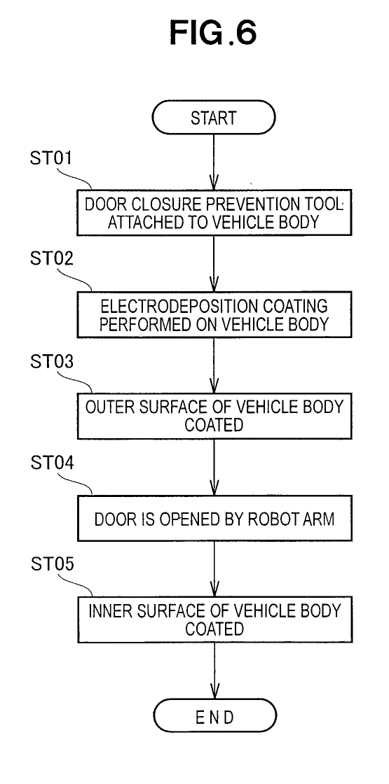

As shown in FIG. 6, in step (hereinbelow abbreviated as ST) 01, the door closure prevention tool (designated as 20 in FIG. 2) is attached to the vehicle body (designated as 10 in FIG. 2), and the door (designated as 11 in FIG. 2) is kept slightly open while preparations for coating are made. Next, in ST02, the vehicle body is immersed in an electrodeposition tank to perform electrode-position coating over the entire vehicle body, forming a primer coating. Next, in ST03, a coating robot coats the outer surface of the vehicle body that has been hoisted out of the electrodeposition tank. In ST04, the door closure prevention tool is operated by a robot arm, and the slightly open door (designated as 11 in FIG. 2) is opened wider. In ST05, the inner surface of the vehicle body is coated by the coating robot.

The aforementioned step ST04 (door opening step) is described in detail below.

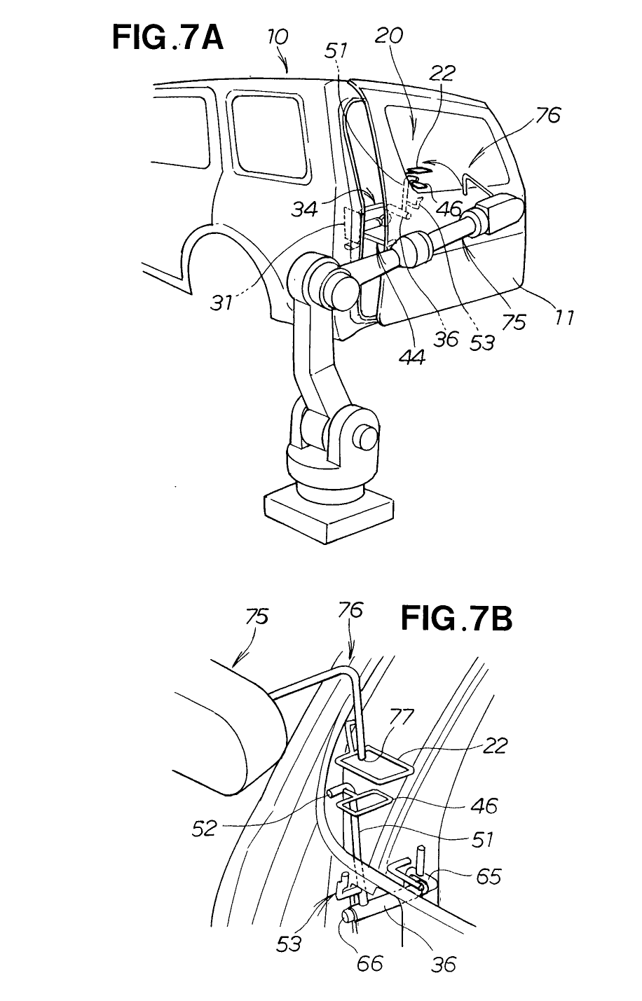

In FIG. 7A, a vertical rod 76 provided to a robot arm 75 approaches the first annular member 46 and the second annular member 22 provided to the door closure prevention tool 20.

In FIG. 7B, a distal end 77 of the vertical rod 76 approaches the area above the first annular member 46 and the second annular member 22.

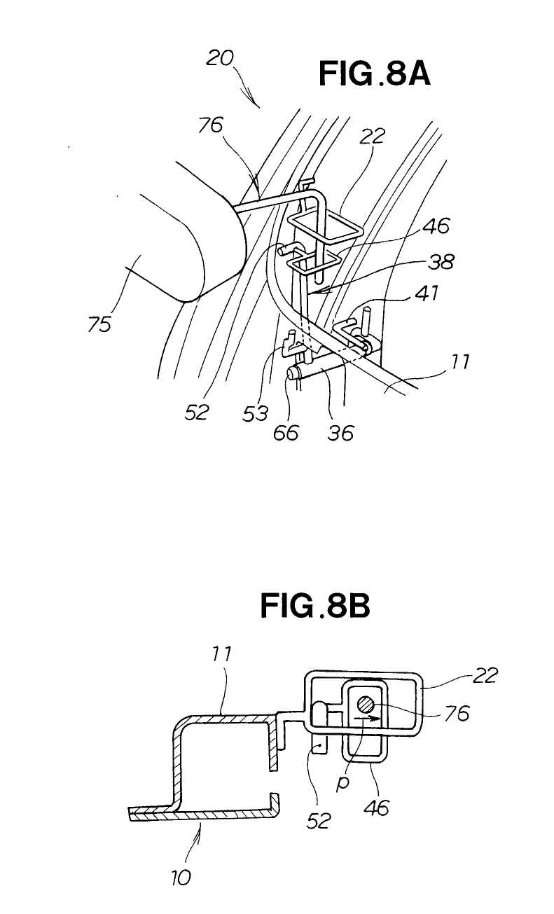

In FIG. 8A, the door closure prevention tool 20 is provided with the second annular member 22 that protrudes horizontally from the side of the door, and the first annular member 46 that protrudes horizontally from the opening restraining member 38. The vertical rod 76 provided at the distal end of the robot arm 75 is inserted through the second annular member 22 and the first annular member 46.

In FIG. 8B, the vertical rod 76 is moved horizontally in the direction of the arrow p after being inserted through the second annular member 22 and the first annular member 46.

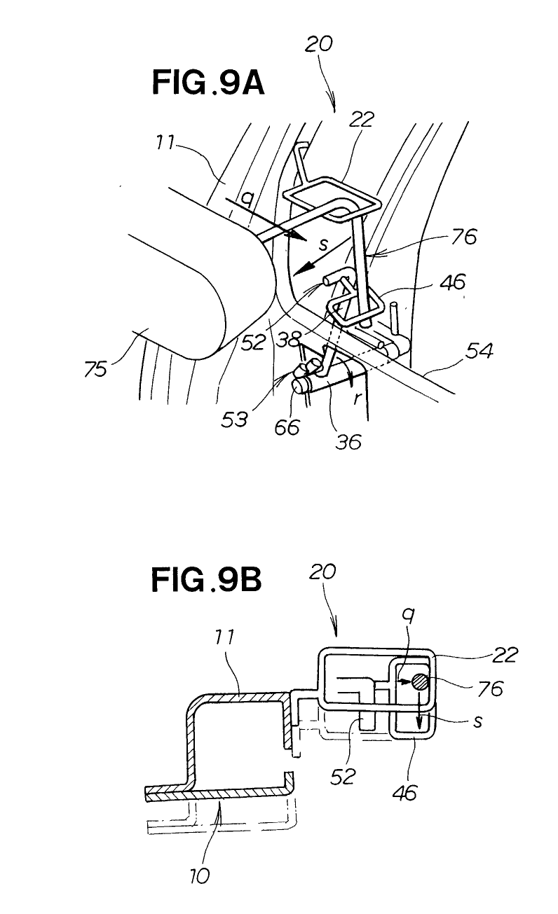

In FIG. 9A, the vertical rod 76 remains inserted through the second annular member 22 and the first annular member 46 while being moved horizontally in the direction of the arrow q. The opening restraining member 38 is rotated in the direction of the arrow r, the restraining function of the opening restraining member 38 is released, and the position after releasing the hold on the open door is maintained while the vertical rod 76 is moved slightly in the direction of the arrow s.

In FIG. 9B, the vertical rod 76 is moved in the direction of the arrow q, and is then moved in the direction of the arrow s. As a result, the second annular member 22 and the door 11 can be moved to the positions indicated by the transparent lines.

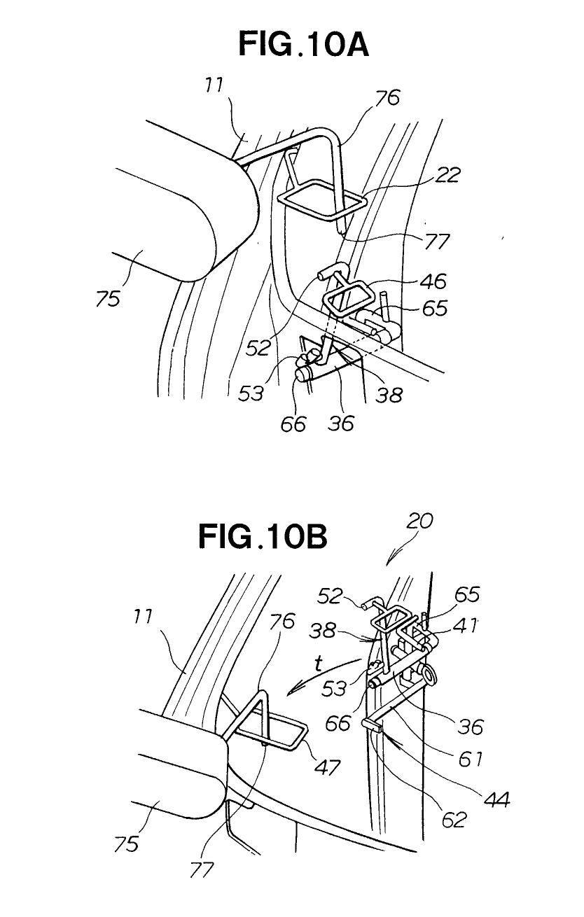

In FIG. 10A, the vertical rod 76 is moved upward until the distal end 77 thereof separates from the first annular member 46. The vertical rod 76 thereby catches only on the second annular member 22.

In FIG. 10B, the vertical rod 76 is moved in the direction of the arrow t, and the door 11 is opened.

In conventional practice, the operation of releasing the lock from the door closure prevention tool 20 has been performed manually. In the present invention, the operation of releasing the lock from the door closure prevention tool 20 is performed by a robot arm. Additionally, the operation of opening the door after the lock is released can also be performed by a robot arm.

The door is a tailgate in the present embodiment, but the door is not limited to a tailgate, and may also be a door in a side of the vehicle body, for example.

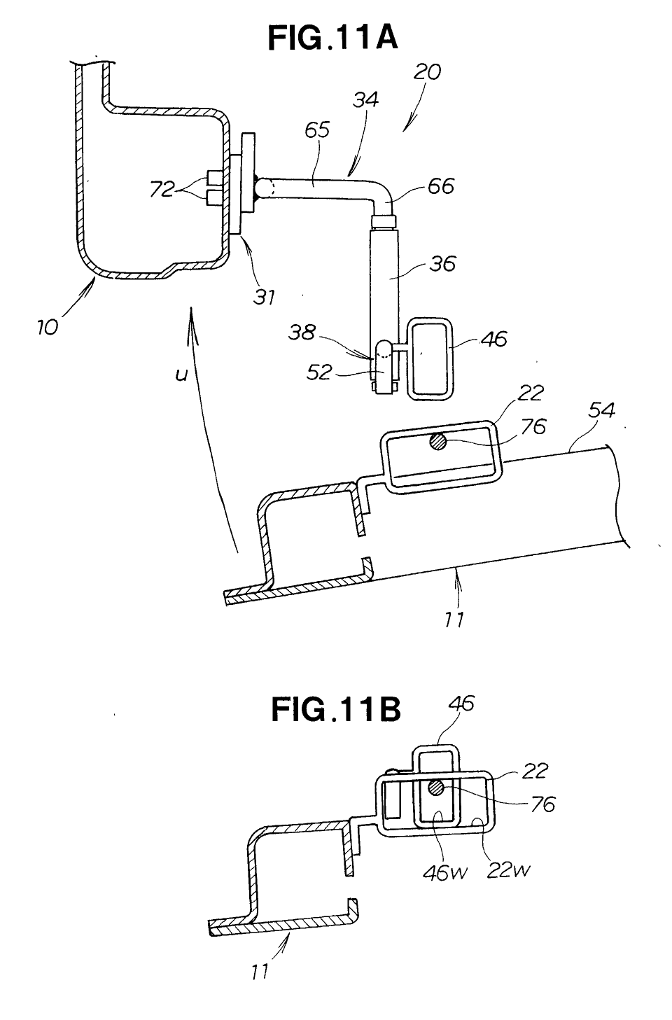

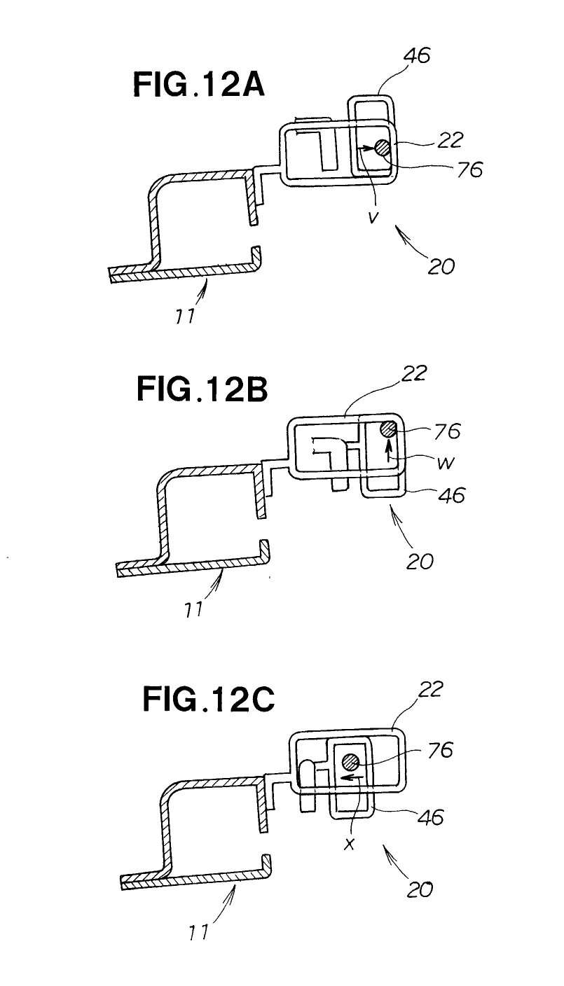

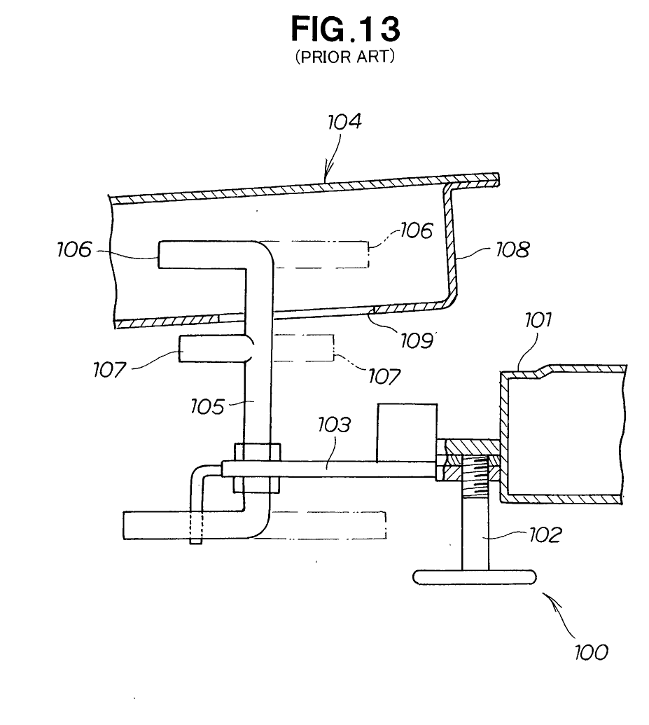

The following is a description, made with reference to FIGS. 11A and 11B and also FIGS. 12A through 12C, of the procedure of bringing an open door 11 to a slightly open position by using the door closure prevention tool 20.

In FIG. 11A, the vertical rod 76 is inserted through the second annular member 22 extending from the door 11, and the door 11 is moved in the direction of the arrow u.

In FIG. 11B, the vertical rod 76 is aligned with the inner side 46w of the ring in the first annular member 46, and the vertical rod 76 is moved from the front of the diagram towards the back so that the vertical rod 76 passes through the inner side 46w of the ring in the first annular member 46 and the inner side 22w of the ring in the second annular member 22.

In FIG. 12A, the vertical rod 76 is moved in the direction of the arrow v, and the first annular member 46 is moved. The result is an arrangement similar to that in FIG. 9B previously described.

In FIG. 12B, the vertical rod 76 is moved in the direction of the arrow w. The door 11 is slightly open as a result.

In FIG. 12C, the vertical rod 76 is moved in the direction of the arrow x, and the door 11 is locked by the door closure prevention tool 20.

As a result of this operation, it is possible to automatically perform a continuous locking operation for a door 11, which operation begins with the door 11 being completely open, and ends with the door closure prevention tool 20 being supported on the vehicle body while the door 11 is slightly open.

The present invention is applied to a coating process for a four-wheeled vehicle in the present embodiment. In addition to a coating process, the present invention can also be applied to an assembly process for a four-wheeled vehicle, which process is intended to save labor.

The present invention can also be applied as a tool used in the assembly of common vehicles other than four-wheeled vehicles.

### INDUSTRIAL APPLICABILITY

The above-described door closure prevention tool is particularly useful for coating vehicles.

1. A door closure prevention tool interposed between a body and a door of a vehicle for bringing the door, which is secured on a right or left side thereof to the vehicle body by hinges, is required to be brought into a slightly open position, the door closure prevention tool comprising:
a tool base fixed to the vehicle body by a screw;
a closure restraining member extending from the tool base towards the door for preventing the door from closing from the slightly open position;
an opening restraining member extending from the tool base to a position of engaging the door for preventing the door from opening farther than the slightly open position;
an elastic member for enabling the opening restraining member to be moved from a position of not engaging the door to the position of engaging the door and to elastically push the opening restraining member to the position of engaging the door;
a first annular member protruding horizontally from the opening restraining member and being operable by a vertical rod provided to a robot arm such that the opening restraining member is moved to a position that does not interfere with the door; and
a second annular member, having a diameter larger than a diameter of the first annular member and protruding horizontally from the door at a position above the first annular member, for opening the door by being operated by the vertical rod which moves the opening restraining member to the position that does not interfere with the door.

2. A vehicle body coating method comprising the steps of:
attaching a door closure prevention tool, according to claim 1, to a predetermined position of a vehicle body having a door;
performing electrodeposition coating on the vehicle body by immersing the vehicle body in an electrodeposition tank with the door kept slightly open via the door closure prevention tool;
coating, by using a coating robot, an outer surface of the vehicle body pulled out of the electrodeposition tank;
causing a vertical rod of a robot arm to act on the door closure prevention tool to completely open the door; and
coating an inner surface, including that of the door, of the vehicle body.
